(19) United States
(12) Patent Application Publication
(10) Pub. No.: US 2014/0297035 A1
(43) Pub. Date: Oct. 2, 2014

(54) EDUCATIONAL ROBOTIC SYSTEMS AND METHODS

(71) Applicant: Tufts University, Medford, MA (US)

(72) Inventors: Marina Umaschi Bers, Arlington, MA (US); Michael S. Horn, Chicago, IL (US)

(73) Assignee: Tufts University, Medford, MA (US)

(21) Appl. No.: 14/242,220

(22) Filed: Apr. 1, 2014

Related U.S. Application Data
(60) Provisional application No. 61/807,085, filed on Apr. 1, 2013.

(51) Int. Cl. B25J 9/16

(52) U.S. Cl. CPC B25J 9/161; Y10S 901/01
USPC 700/257; 700/264; 901/1

(57) ABSTRACT

The present invention relates to education robotics systems and methods. In particular, the present invention provides robotic systems comprising tangible and graphic programming interfaces suitable for use by young children.

This application claims priority to U.S. Provisional Application No. 61/807,085, filed Apr. 1, 2013, which is herein incorporated by reference in its entirety.

### FIELD OF THE INVENTION

The present invention relates to education robotics systems and methods. In particular, the present invention provides robotic systems comprising tangible and graphic programming interfaces suitable for use by young children.

### BACKGROUND OF THE INVENTION

There is a growing interest in the field of robotics as an educational tool. However, little is focused on the foundational schooling years. However, both from an economic and a developmental standpoint, educational interventions that begin in early childhood are associated with lower costs and more durable effects than interventions that begin later on (e.g., Cunha & Heckman, 2006 American Economic Review, 97(2), 31-47.4). Two National Research Council reports—Eager to Learn (2001) and From Neurons to Neighborhoods (2002) document the significance of early experiences for later school achievement. The National Science Board urged the Obama administration to make science, technology, engineering, and mathematics (STEM) education a priority in early childhood education, writing that, “the earlier children are exposed to STEM concepts, the more likely they are to be comfortable with them later in life.” The current presidential administration has pledged to do so (National Science Board, 2009). Along with the goal to increase comfort levels, these reports reflect a belief that early experiences are critical. Research also shows that introducing STEM in early childhood might help to avoid stereotypes and other impediments to entering the innovation pipeline later on (Markert, 1996 The Journal of Technology Studies, 22(2), 21-29).

However, there are three major impediments for bringing technology and engineering into early childhood education. First, among early childhood educators there is a lack of knowledge and understanding about technology and engineering, and about developmentally appropriate pedagogical approaches to bring those disciplines into the classrooms (Bers, 2008 Blocks, robots and computers: Learning about technology in early childhood. New York: Teacher's College Press). New professional development models and strategies are needed to prepare early childhood teachers for this task.

Second, there is a need of new technologies with design affordances and interfaces specifically developed for young learners. Without these, the results of the investment on professional development will not scale, as it will be difficult for teachers to integrate the use of technology into their classrooms.

Third, it is believed that young children cannot learn or benefit in a developmentally appropriate way from STEM systems that are designed for older children with more advanced development and capabilities. Thus, it is not clear which, if any, tools will be suitable or useful for younger children.

### SUMMARY OF THE INVENTION

The present invention relates to education robotics systems and methods. In particular, the present invention provides robotic systems comprising tangible and graphic programming interfaces suitable for use by young children.

Embodiments of the present invention provide compositions, systems, and methods that provide easy to use educational robotics targeted to young children (e.g., age 7 or under, for example, ages 2-7, 3-7, 3-6, 3-5, 3-4, 4-7, 4-6, 4-5, 5-7, or 5-6). The systems and methods describe herein meet an unmet need for robots suitable for programming and use by young children.

For example, in some embodiments, the present invention provides a system (e.g., for use by a child aged 7 and under, for example, ages 4-7), comprising: a) a robot comprising i) a robot ii) at least one (e.g., 1, 2, 3, 4, or more) sensor ports configured to receive at least one (e.g., 1, 2, 3, 4, or more) sensor; and iii) at least one (e.g., 1, 2, 3, 4, or more) motor port configured to receive at least one (e.g., 1, 2, 3, 4, or more) motor; and b) a programming interface configured to receive graphical and/or tangible programming instructions and transmit the instructions to the robot. The present invention is not limited to particular types of sensors. Examples include, but are not limited to, sound sensors, light sensors, or distance sensors. In some embodiments, the robot further comprises a light output. In some embodiments, the tangible programming instructions comprise physical objects and/or pieces of paper comprising printed programming instructions. In some embodiments, the physical objects are connectable blocks with labels comprising programming instructions printed thereon. In some embodiments, the physical objects comprise a bar code scanner code and/or color scanner code and the robot comprises a bar code reader and/or a color scanner. In some embodiments, In some embodiments, it is not necessary to connect the robot to a computer to read the programming instructions. In some embodiments, the system further comprises a camera (e.g., internal or external to the programming interface). In some embodiments, the programming interface comprises a computer processor and computer software. In some embodiments, the computer processor is on a personal computer, a tablet computer, or a smart phone. The present invention is not limited to particular programming instructions. Exemplary programming instructions include, but are not limited to, BEGIN, END, FORWARD, BACKWARD, TURN LEFT, TURN RIGHT, SPIN, SHAKE, SING, BEEP, LIGHT ON, LIGHT OFF, END-REPEAT, END-IF, IF-NOT, END-IF-NOT, REPEAT, IF, NEAR, FAR, LOUD, QUIET, LIGHT, DARK, UNTIL NEAR, UNTIL FAR, UNTIL LOUD, UNTIL QUIET, UNTL LIGHT, or UNTIL DARK. In some embodiments, the robot comprises a grammar checking component (e.g., connected to a LED and a speaker) configured to provide visual and/or auditory feedback to the user regarding the presence or absence of grammatical errors. In some embodiments, the robot body further comprises a power source. In some embodiments, the robot body further comprises a communications component for communicating with the programming interface (e.g., including but not limited to, a universal serial bus port, a Bluetooth communications component, and near field communications component, or a WiFi communications component). In some embodiments, the sensors, motors, sensor ports, and motor ports comprise a connector component (e.g., magnets) configured to attach the sensors to sensor ports and the motors to motor ports. In some embodiments, the motors operate at one or two fixed speeds. In some embodiments, the motors do not move the robot or move the robot. In some embodiments, the sensors are a shape that represents their sensing ability (e.g., the light sensor is eye shaped, the sound sensor is ear shaped, and the distance sensor is block shaped). In some embodiments, the sensors and sensor ports are modular (e.g., in some embodiments, sensors of different types can be interchangeably placed in any sensor port). In some embodiments, the system comprises 3 or fewer motors and motor ports (e.g., 1, 2, or 3); 4 or fewer sensors and sensor ports (e.g., 1, 2, 3, or 4); and one light output. In some embodiments, each of the programming instructions corresponds to a single robot action. In some embodiments, the robot and programming component is configured to withstand use by children aged 7 and under (e.g., the robot remains intact if the robot contacts a solid surface). In some embodiments, components of said robot and said programming interface are composed of a variety of different materials. In some embodiments, the robot body is transparent or translucent (e.g., to allow children aged 7 and under to see the inner workings of the robot). In some embodiments, the system is configured to teach literacy and math (e.g., by utilizing age appropriate reading and math skills). In some embodiments, the robot body is approximately 9 inches by 5 inches (e.g., between approximately 7 and 9 inches by between approximately 4 and 5 inches). In some embodiments, sensors are approximately 1-2 inches by 1-2 inches. In some embodiments, motors approximately 1.5 inches by 3 inches (e.g., approximately 2 inches by 2.5 inches). In some embodiments, the robot body weighs less than one pound (e.g., between approximately 0.5 pounds and 1 pound).

Further embodiments provide a method, comprising: a) programming (e.g., by a young child) a sequence of commands using a programming interface configured to receive graphical and/or tangible programming instructions; and b) transmitting the instructions to a robot comprising i) a robot; ii) at least one (e.g., 1, 2, 3, 4 or more) sensor port configured to receive at least one (e.g., 1, 2, 3, 4, or more) sensor; and iii) at least one (e.g., 1, 2, 3, 4, or more) motor port configured to receive at least one (e.g., 1, 2, 3, 4, or more) motors. In some embodiments, the programming comprises combining tangible or graphical instructions in sequencing combinations. In some embodiments, the tangible instructions are transferred to the programming component by photographing them with a camera operably linked to the programming component.

Additional embodiments of the present invention provide a kit, comprising: a) the system as described herein; and b) one or more instructional components useful, necessary, or sufficient for utilizing the system in instructing children aged 7 and under (e.g., printed curriculum instructions, an instructional video, or teaching aids).

The present invention also provides a method of instructing a child aged 7 or under, comprising: a) providing a system as described herein to a child aged 7 or under; and b) instructing the child in programming a sequence of commands using said programming interface; and transmitting the instructions to the robot.

Additional embodiments are described herein.

### DESCRIPTION OF THE FIGURES

FIG. 1 shows the KIWI Robot and CHERP Tangible-Graphical Programming Interface.

FIG. 2 shows an exemplary robot body, port locations, and motors.

FIG. 3 shows labels for graphical or tangible programming interface commands. A. Graphical interface download button. B. Tangible interface download button. C. Begin. D. End. E. Repeat forever. F. Shake. G. End repeat.

FIG. 4 shows alignment of codes for an If block with the block and additional commands.

### DEFINITIONS

The term “user” refers to a person using the systems or methods of the present invention. In some embodiments, the user is a young child (i.e., age 7 or under, for example, ages 2-7, 3-7, 3-6, 3-5, 3-4, 4-7, 4-6, 4-5, 5-7, or 5-6).

As used herein, the term “programming interface” refers to electronic and/or physical components used to generate, process, and transmit programming instructions. In some embodiments, programming interfaces comprise graphical and/or tangible programming components for generating sequences of programming commands. In some embodiments, programming interfaces further comprise computer processors, graphical interfaces, and other electronic components (e.g., cameras, electronic communications components, etc.).

As used herein, the terms “processor” and “central processing unit” or “CPU” are used interchangeably and refer to a device that is able to read a program from a computer memory (e.g., read only memory (ROM) or other computer memory) and perform a set of steps according to the program.

As used herein, the term “in electronic communication” refers to electrical devices (e.g., computers, processors, etc.) that are configured to communicate with one another through direct or indirect signaling. A computer configured to transmit (e.g., through cables, wires, infrared signals, telephone lines, etc) information to another computer or device, is in electronic communication with the other computer or device.

As used herein, the term “approximately” refers to a value close to a recited value (e.g., plus or minus 10%, 9%, 8%, 7%, 6%, 5%, 4%, 3%, 2%, 1%, or fractions thereof).

As used herein, the term “transmitting” refers to the movement of information (e.g., data) from one location to another (e.g., from one device to another) using any suitable means.

### DETAILED DESCRIPTION OF THE INVENTION

The present invention relates to education robotics systems and methods. In particular, the present invention provides robotic systems comprising tangible and graphic programming interfaces suitable for use by young children.

Early childhood educators demonstrate a lack of knowledge and understanding about technology and engineering, and about developmentally appropriate pedagogical approaches to bring those disciplines into the classrooms. In the early grades, children learn very little about technology. For decades early childhood curriculum has focused on literacy and numeracy, with some attention paid to science, in particular to the natural world. While understanding the natural world is important, developing children's knowledge of the human-made world is also needed (Bers, 2008 Blocks, robots and computers: Learning about technology in early childhood. New York: Teacher's College Press). This is the realm of technology and engineering, which focus on the development and application of tools, machines, materials, and processes to solve human problems. Just as it is important to begin science instruction in the early years by building on children's curiosity about the natural world, it's as important to begin engineering instruction and the development of technological literacy by building on children's natural inclination to design and build things, and to take things apart to see how they work (Resnick, 2007 Learning & Leading with Technology, 35(4), 18-22).

Early childhood education has not ignored this; it is common to see young children using recycled materials to build cities and bridges. However, what is unique to the human-made world today is the fusion of electronics with mechanical structures. In the modern world, bits and atoms are increasingly integrated (Gershenfeld, 2000 When things start to think. New York: Henry Hold and Co); however, young children are taught very little about this.

Recent work has addressed this challenge by studying how the field of robotics offers a type of educational technology that holds special potential for early childhood classrooms (Bers & Horn, 2010 Tangible programming in early childhood: Revisiting developmental assumptions through new technologies. In I. R. Berson & M. J. Berson (Eds.), High-tech tots: Childhood in a digital world (pp. 49-70). Greenwich, Conn.: Information Age Publishing; Bers, 2008b Engineers and storytellers: Using robotic manipulatives to develop technological fluency in early childhood. In O. Saracho & B. Spodek (Eds.), Contemporary Perspectives on Science and Technology in Early Childhood Education (pp. 105-125). Charlotte, N.C.: Information Age Publishing; Kazakoff & Bers, 2012). Robotics facilitates cognitive as well as motor and social skills development, which are all important for young children. Given the increasing mandate to make early childhood education more academically challenging, while honoring the importance of play in the developmental trajectory, robotics can provide a playful bridge to integrate academic content with meaningful projects. Furthermore, in early childhood content areas tend not to be isolated, but integrated more broadly into classroom curriculum that encompasses different content and skills; thus robotics can serve as integrator of curricular content (Bers, Ponte, Juelich, Viera, & Schenker, 2002; Information Technology in Childhood Education, 123-145). Young children can become engineers by playing with gears, levers, motors, sensors, and programming loops, as well as storytellers by creating their own meaningful projects that react in response to their environment (Bers, 2008,supra). Robotics can also be a gateway for children to learn about applied mathematical concepts, the scientific method of inquiry, and problem solving (Rogers & Portsmore, 2004 Journal of STEM Education, 5(3-4), 14-28). Moreover, robotic manipulatives invite children to participate in social interactions and negotiations while playing to learn and learning to play in a creative context. However, in order for robotics to be successfully used in the classroom, teachers need to understand its potential benefits and best pedagogical approaches to implement integrated curriculum.

Prior to the development of the present disclosure, developmentally appropriate robotic kits that can be successfully used and integrated into the early childhood classroom were not available. Indeed, the educational community believed that young children are not able to learn or benefit from STEM systems that are designed for older children with more advanced development and capabilities. Thus, it was not clear which, if any, tools will be suitable or useful for younger children.

Many robotic construction kits are in the market or have been developed by research universities. Educational robotic kits are a new generation of learning manipulatives that build on the tradition of Montessori and Fröebel, whose “manipulatives” and “gifts” were designed to help young children develop a deeper understanding of mathematical concepts such as number, size, and shape. More recently, “digital manipulatives” expand the range of concepts that children can explore. For example, by embedding small sensors, motors, lights, or speakers along with computational power, robotic kits allow children to learn about dynamic processes and “systems concepts,” such as feedback, as well as develop technological literacy and engage in computational thinking.

However, very few commercially available robotic kits have been explicitly designed for young children under seven years old. One of the few examples is the Bee-Bot, a small plastic robot with a shape of a bee that has directional keys on its back that are used to enter up to 40 commands which send Bee-Bot forward, back, left, and right. However, children do not have opportunities to engage in the building of the robotic artifact and thus explore engineering ideas, neither can they engage in programming that involves both sequencing and control flow.

The robotics systems and methods described herein are specifically designed for young children (e.g., 4 to 7 years old) and its design features are driven by developmentally appropriate practice (DAP) and theories of child development. The concept of DAP was coined in 1986 in a NAEYC (National Association for the Education of Young Children) position paper. It provides principles that are based on child development theories and that are widely embraced by early childhood educators. In summary, DAP focuses on age, individual and socio-cultural appropriateness.

Based on the concept of DAP, the robotics systems of embodiments of the present invention have the following design features that are: 1) age appropriate and therefore establish reasonable expectations of what is interesting, safe, achievable and challenging for the children to do with the systems; 2) individually appropriate in that they engage children with different learning styles, background knowledge, exposure and skills in the technological domain, and different developmental abilities and self-regulatory skills; and 3) socially and culturally appropriate in that the use of the systems can be integrated with multiple disciplines and can support the teaching of interdisciplinary curriculum units that correspond to state and nationally mandated frameworks.

More specifically, 10 fundamental guiding principles characterize the DAP philosophy and informed the design of the robotics systems of embodiments of the present invention. These are:

1. Addressing the whole child (supports cognitive, social, emotional, and motor development in an integrated way).
2. Individualizing the experience to suit particular children (design features accommodate different learning styles and developmental abilities in the continuum pre-operational to concrete cognitive stage development studied by Piaget and followers. They also engage children with different preferences in terms of sensory skills and self-regulatory mechanisms).
3. Recognizing the importance of child-initiated activity (e.g., by providing an open ended system that can be built and programmed by the child with a minimum level of instruction, it offers opportunities for challenges that reward persistence and motivation. Children should be challenged to achieve at a level just beyond their current mastery, and should have many opportunities to practice newly acquired skills. At the same time, children need to be successful in new tasks a significant proportion of the time in order for their motivation and persistence to remain).
4. Recognizing the significance of play as a vehicle for learning (e.g., design features promote playfulness in many different ways. Children engage in various kinds of play, such as physical play, object play, pretend or dramatic play, constructive play, and games with rules—programming. Research shows the links between play and foundational capacities such as memory, self-regulation, oral language abilities, social skills, and later success in school).
5. Creating flexible, stimulating learning environments (e.g., offers flexibility and stimulation by providing opportunities for children to engage in programming, to experiment with different kinds of motion to build stationary and mobile artifacts, to work with sensors so the robot can react to stimulus in the environment)
6. Using an integrated curriculum (design takes into consideration state and federally mandated content areas and skills).
7. Learning by doing (modularity engages the children in learning by building, programming and using arts and crafts and recyclable materials).
8. Giving children choices about what and how they learn (design offers many choices, both in terms of programming and building).
9. Continually assessing children's learning through a variety of strategies (offers immediate feedback, through its design, so children can understand the need to use a different strategy).
10. Forming partnerships (the size of the robotics systems of embodiments of the present invention invites social interactions around the robot itself and the hybrid programming environment).

Following is a list of design features of robotics systems of embodiments of the present invention that are designed to fulfill the 10 DAP guiding principles and child development and learning theories. Emperical testing has confirmed their success.

Programability—The robot is given child-created action instructions and control flow instructions that follow a logical sequence in which order matters (as opposed to a remote controlled or pre-programmed robot). This design feature engages children in cognitive development by providing a concrete medium for working with abstract ideas. It also promotes sequencing skills, fundamental developmental milestone for children in this age range. A six-year-old becomes more able to plan a series of actions to fulfill a goal and to think flexibly in doing so, and cognition in this stage is aided by increasing memory capacity and meta-cognition

Hybrid Programming Environment—The robot is programmed through a hybrid programming interface. It provides options for both tangible and graphical programming of the robot's actions. In both cases, there is a visible and shareable code that children create and manipulate. Children can easily transition between tangible and graphical programming interfaces. This design feature engages children in working with multiple representations, a skill that is fundamental for young children and that is always available in developmentally appropriate math and literacy programs for young children.

Sensing—Sensing is the ability of the robot to collect and respond to information on its environment. Sensors include, but are not limited to, light, sound, and distance. Developmentally, children are exploring both human and animal sensors, the design of the sensor modules allows them to draw similarities and differences.

Versatile Motion—Ability of the robot to create both stationary and mobile motion. Multiple motors are included with the robot and are, for example, connected to the opposite sides of the robot for mobility. In some embodiments, one motor is located on top for rotation of an attached element. Children can decided which motors they want to connect, but, in some embodiments, they cannot control the speed of the motors. This design feature is aligned with the importance of creating flexible and stimulating learning environments that do not overload young children's working memory and limited attention span.

Symbolic Representation—Intuitive labels for robot parts and programming language. The programming language, icons, and robotic components, are made of intuitive symbols representing their meaning (e.g., ear-shaped part represents sound sensor). This helps children establish direct one on one connections. During the late pre-operational stage of cognitive development (ages 4-6), children extend and apply culturally-learned symbol systems to interactions with the physical and social world. The explicit emphasis on design features with symbolic representations support this transition.

Modularity—The robot is composed of different modules (e.g., motors, sensors, outputs) that are interchangeably combined on the robot body. Different combinations are available. Children are in control of these choices thus promoting self-directed learning and autonomy, a fundamental developmental milestone for this age group, as well experimentation, a developmental mechanisms used to achieved that milestone.

Simplicity of design—There are a limited number of ways to construct and program the robot. The robot has a limited number of component types and limited number of possible combinations for these components (e.g., 3 motors, 1 light output, 3 sensors). In some embodiments, the robot has 3 or fewer motors (e.g., 1, 2, or 3), 1 light output and 3 or fewer sensors (e.g., 1, 2, or 3). There is a limited number of control points for the child (e.g., children can tell the robot to go forward or backward but not how fast). Sensors sense presence or absence of stimuli but not the degree of variation within the stimuli. In some embodiments, children perform 4 or fewer tasks at a time (e.g. 1, 2, 3, or 4).

One-to-One Correspondence—Each basic programming instruction corresponds to one robotic action. Each robotic component corresponds to one function—only one module is needed for each ability (e.g., only the motor module is needed to move the robot—gears, connectors, etc. are contained within the motor module). To develop one to one correspondence is a developmental milestone for young children and is a foundational skill for later academic learning.

Sturdiness—A robot that can be easily manipulated by a young child without falling apart. The robot remains intact while being handled and used in ways typical of young children (e.g., dropping, running into walls, etc.). This design feature is aimed at supporting children's developing fine motor skills and lack of extended self-regulation practices. In some embodiments, the robot is configured to withstand manipulation by a young child. In some embodiments, components of the robot (e.g., sensors and/or motors) remain intact if the robot contacts a solid surface (e.g., wall or floor).

Size of robot body and component—Pieces are large enough to be easily manipulated and assembled safely by young children (e.g., nothing they can swallow, etc.). The body has the right weight and size to be manipulated by a young child's hands. Size of robot allows it to be shareable to promote social interaction between kids, and to be easily manipulated even though children might lack fine motor skills. In some embodiments, the robot body is approximately 9 inches by 5 inches (e.g., between approximately 7 and 9 inches by between approximately 4 and 5 inches). In some embodiments, sensors are approximately 1-2 inches by 1-2 inches. In some embodiments, motors approximately 1.5 inches by 3 inches (e.g., approximately 2 inches by 2.5 inches). In some embodiments, the robot body weighs less than one pound (e.g., between approximately 0.5 pounds and 1 pound).

Consistency of performance—Sensors and motors behave within a tight range of performance, creating a consistent experience for children. This is important for young children who need to be able to predict behaviors. In some embodiments, sensor sense a specific range of light, sound, distance, etc. In some embodiments, motors operate at a single speed or 1 or more (e.g., 2) defined speeds.

Supports Integration of Different Materials—The robot and its modules are composed of different materials. Children can connect and add recyclables and arts and crafts materials of their choosing in order to promote a variety of sensory and aesthetic experiences for young children. In some embodiments, additional design or physical components (e.g., paper, plastic, metal, etc.) are added to the robot.

Personalized Space—The robot should have sufficient empty space on its body for children to incorporate the use of other materials (arts, crafts, recyclables) in order to complete its look. The robot's look can be adapted to match curriculum or children's backgrounds and ideas. The personalized spaced supports interdisciplinary curriculum. In some embodiments, the robot has 20-60% (e.g., approximately 20%, 30%, 40%, 50%, 60%+/−1, 2, 3, 4, or 5%) empty space.

Reveal “Inner Workings” (electronics inside)—The robot presents design features that allow children to see how it works. This introduces children to the concept of circuit boards and digital literacy, so children can understand that “it's not magic”, there are electronic components that “give life” to the robot. In some embodiments, one or more of the robot body, sensor(s), or motor(s) is made of a transparent or translucent material (e.g., plastic).

Plug and Play Connection System—The robot parts or modules connect and disconnect intuitively and easily. They are functional with no further steps other than plugging them in. Additionally, correct orientation of parts is forced through the design. For example, in some embodiments, the components are interlocking and only connect in a single orientation.

Low-Cost—The simplicity of functionality allows for a low cost implementation of Design features are guided by the need to maintain the low cost. For example, in some embodiments, complete systems (e.g., including all components for building and programming robots and optionally including instructional material) cost between $60 and $150.

Scaffolded Problem Solving—The robotic kit and programming language shifts problem solving focus away from low-level problems (e.g., syntax and connection errors) towards high level problem solving (e.g., creating a program that matches your goal). This allows children to engage in problem solving in a developmentally appropriate way that takes into consideration their levels of self-regulation. Furthermore, during the late pre-operational stage of cognitive development (ages 4-6), children use patterns of reasoning which are compelling to the child and yet which defy adult logic. Thus, the simple and more straight forward the design of the system, the more limited the domain for problem solving. This is important as the reasoning of children in this stage is shaped by challenges in rationally relating multiple dimensions, distinguishing appearances from reality, taking multiple psychological and physical perspectives, and carrying out mental manipulations of objects in reverse.

Supports Early Literacy—The programming language pairs iconic images and simple words and allows children to explore with sequencing, a foundational skill for literacy development. Developmentally appropriate practice calls for interdisciplinary curriculum. In this case, the robotics systems are supporting the integrated learning of technology and engineering with literacy.

Supports Early Math—The programming language encourages children to play with number size, measurement, distance, time, counting, directionality, and estimation. DAP calls for interdisciplinary curriculum. In this case, the robotic systems are supporting the integrated learning of technology and engineering with mathematics.

The systems and method described herein provide robotics systems that can be programmed and operated by young children (i.e., ages 7 or under). In some embodiments, the systems and methods described herein are suitable for use by children ages, 2-7, 3-7, 3-6, 3-5, 3-4, 4-7, 4-6, 4-5, 5-7, or 5-6. In some embodiments, systems and methods comprise two components, the robot and associated components; and the programming interface.

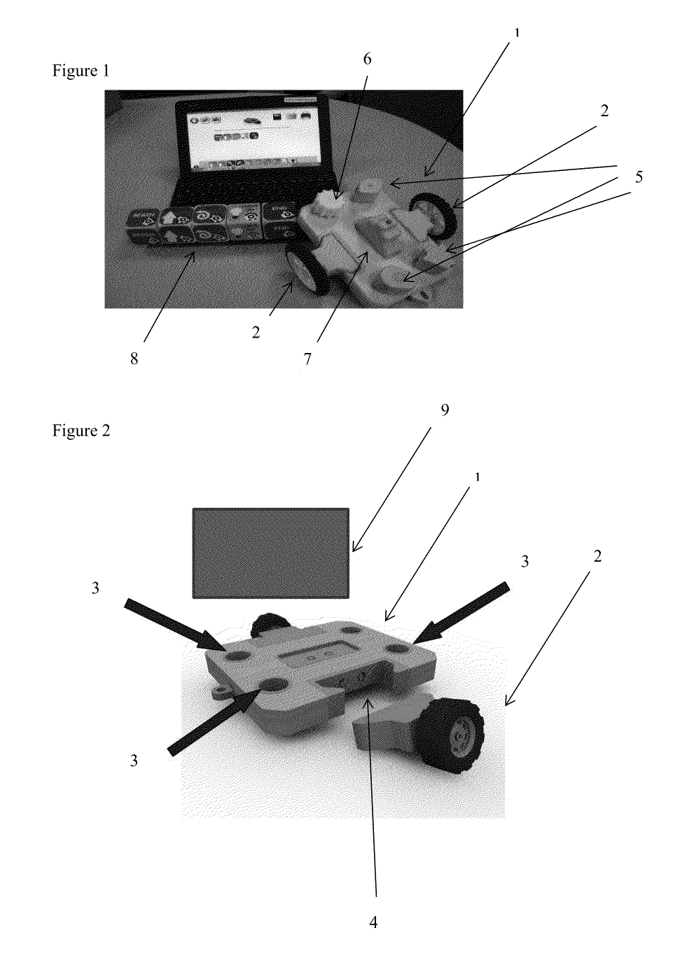

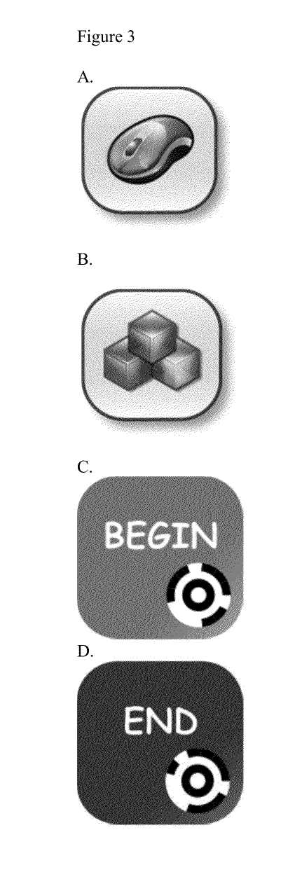

An exemplary overview of robotics of embodiments of the present invention is shown in FIGS. 1 and 2. FIG. 1 shows an overview of the robot body 1 with motors 2, sensors 5, light output 6, and power supply 7. FIG. 2 shows the robot body 1 with sensor ports 3, motors 2, and motor ports 4. In some embodiments, the robot body 1 comprises 1 or more (e.g., 1, 2, 3, 4, or more) sensor ports 3 for attaching sensors 5. In some embodiments, the robot body 1 comprises 1, 2, 3, or 4 sensor ports 3. Any suitable method of attaching sensors 5 to sensor ports may be utilized. In some embodiments, sensors 5 are attached to sensor ports 3 using magnets attached to the sensor 5 and the sensor port 3. In some embodiments, connectors are modular and easy for small children to manipulate. In some embodiments, the sensors 5 connect to the sensor ports 3 in only a single orientation. The present invention is not limited to a particular type of sensor 5. Examples include, but are not limited to, light, sound, and distance sensors 5. Additional sensor types may be utilized.

In some embodiments, the robot body 1 comprises one or more light outputs 6. The present invention is not limited to a particular type of light output 6. Examples include, but are not limited to, incandescent, fluorescent, or LED lights.

In some embodiments, the robot body 1 comprises 1 or more (e.g., 1, 2, 3, 4, or more) motors 2 and motor ports 4. In some embodiments, the robot body 1 comprises 1, 2, or 3 motors 2 and motor ports 4. In some embodiments, motors 2 comprise wheels for moving the robot. In some embodiments, motor ports 4 are a different shape than sensor ports 3 to avoid confusion. In some embodiments, motors 2 are attached to motor ports 4 using magnets attached to the motor 2 and the motor port 4.

In some embodiments, the motor body 1 comprises a power supply 7. Any suitable power supply may be utilized (e.g., to power motors and light outputs). In some embodiments, the power supply is powered by batteries (e.g., disposable or rechargeable batteries). In some embodiments, the motor body 1 is powered by connecting to a computer or portable electronic (e.g., via USB).

Embodiments of the present invention provide a programming interface for programming the robot body 1. An overview of the programming interface is shown in FIG. 1. In some embodiments, programming interface comprises a computer or other electronic device (e.g., tablet computer, smart phone, etc.) comprising a graphical programming interface and a tangible programming interface 8.

In some embodiments, the robot comprises an optional platform 9 (e.g., for integrating additional components such as artwork into the robot) that mounts on top of the robot body. In some embodiments, the platform is constructed of a variety of materials (e.g., plastic, wood, magnetic materials, etc.).

In some embodiments, the programming interface is a graphical interface (e.g., graphics displayed by computer software on a display screen).

In some embodiments, the tangible programming interface 8 comprises a series of labeled, interlocking physical components. FIG. 1 illustrates square blocks. However, other suitable shapes and physical configurations are specifically contemplated. In some embodiments, pieces of paper with labels printed on them are used for tangible programming.

In some embodiments, the robot read the physical components comprising programming language by any suitable method. Examples include, but not limited to, connecting the robot to a computer (e.g., using component described herein), integrating a bar code scanner into the robot that reads each of the blocks (e.g., blocks comprising a scanning tag), or integrating a color scanner into the robot that reads each of the blocks (e.g., blocks comprising a an area with a color that can be scanned and understood by the robot). In some embodiments, it is not necessary to connect the robot to a computer to read the programming instructions (e.g., embodiments where the robot comprises an integrated reader or scanner).

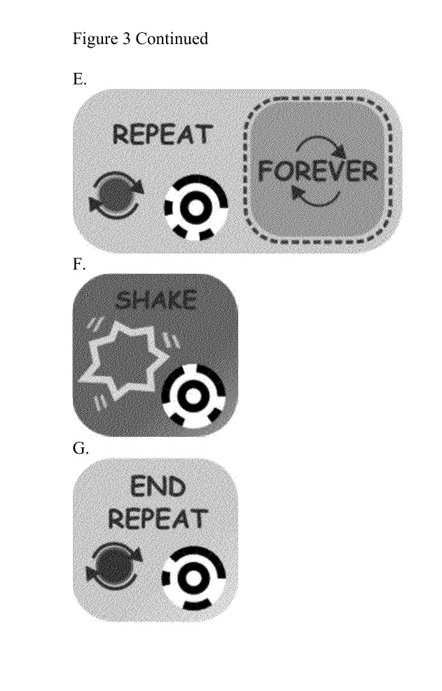

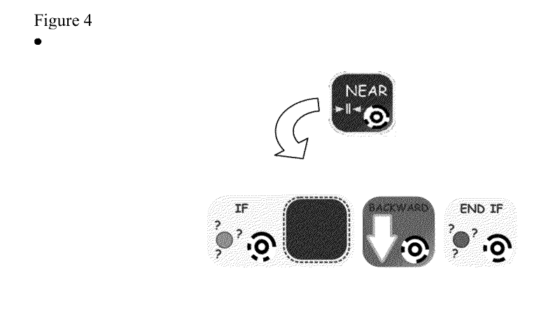

Both graphical and tangible programming interfaces utilize a series of simple, easy to understand commands. Exemplary commands are shown in FIGS. 3 and 4 and include, but are not limited to, BEGIN, END, FORWARD, BACKWARD, TURN LEFT, TURN RIGHT, SPIN, SHAKE, SING, BEEP, LIGHT ON, LIGHT OFF, END-REPEAT, END-IF, IF-NOT, END-IF-NOT, REPEAT, IF, NEAR, FAR, LOUD, QUIET, LIGHT, DARK, UNTIL NEAR, UNTIL FAT, UNTIL LOUD, UNTIL QUIET, UNTL LIGHT, or UNTIL DARK.

In some embodiments, one or more labels are used in combination. For example, a REPEAT or IF, END-IF, or END-IF-NOT label can be combined with a FOREVER label or a UNTIL (e.g., UNTIL LOUND, UNTIL QUIET, UNTIL DARK, UNTIL LIGHT, etc.) label.

In some embodiments, the programming interface comprises a camera (e.g., internal or external to a computer) for interacting with the tangible programming interface.

In some embodiments, the programming interface is connected to the robot body via an electronic interface. Examples include, but are not limited to, a universal serial bus port, a Bluetooth communications component, and near field communications component, and a WiFi communications component.

In some embodiments, the robot comprises a grammar checking component (e.g., connected to a LED and a speaker) that provides visual and/or auditory feedback to the user regarding the presence or absence of grammatical errors.

In order to program the robot body, a user (e.g., young child) combines a series of commands using either a graphical programming interface (e.g., on an electronic device) or using a tangible programming component. If a tangible programming interface is utilized, the user then takes a picture of the string of tangible programming components using a camera connected to the computer or other electronic device. The computer then executes the program and transfers it to the robot body via an electronic communication component. If the robot comprises a power source, the robot can be disconnected from the computer and allowed to perform the program. The sequence can be repeated multiple times with multiple programs.

As described above, the robotic systems and methods of embodiments of the present invention find use in educational (e.g., school, child care, home) settings. Children are able to experiment with different programming sequences and commands using the simple, easy to use programming and robot components described above.

In some embodiments, the systems are provided as part of a kit for educational or other use (e.g., for use by a teacher, parent, or child care provider). In some embodiments, the kits comprise the robotic systems as described herein and one or more additional component useful, necessary, or sufficient for utilizing the systems (e.g., printed curriculum instructions, an instructional video, or teaching aids).

### EXPERIMENTAL

The following examples are provided in order to demonstrate and further illustrate certain preferred embodiments and aspects of the present invention and are not to be construed as limiting the scope thereof.

### Example 1

### CHERP-KIWI

KIWI (Kids Invent with Imagination) Construction Set

The KIWI construction set enables young children (5-7) to engage in robotics activities in a developmentally appropriate way. The KIWI set contains different elements including two motors, a sound sensor, a distance sensor, a light sensor, a light output, and a proper USB cable. The robot can connect to the computer using the USB cable to receive the program that controls its act. The programming language that is used to program the KIWI robot is called CHERP. FIG. 2 shows a description of the KIWI pieces that can attach to the robot's main body and perform different tasks.

The pieces can be explained by comparing them to body part. There are three different spots for the motors to attach to the robot body. Two are on the side of the robot, one on the top. Two motors are included in each construction kit. The robot can be mobile or stationary. If the motors get attached to the sides and become wheels, the robot will be mobile. If one motor, gets attach to the top spot, the robot will be stationary. The motors can be programmed to turn this way or that way.

The robot includes sound, light, and distance sensors. The Sound sensor is used to differentiate the two concepts of “Loud” and “Quiet”. Using the Sound Sensor, the robot can be programmed to do something when it is loud, and do something else when it gets quiet, or vice versa

The Light sensor is used to differentiate the two concepts of “Dark” and “Light”. If the room is darker than a specific level, the sensor considers that as Dark. Otherwise, the room will be considered Light. The robot can be programmed to do some things when it is light outside, and do something else when it gets dark, or vice versa.

The Distance sensor is used to detect whether the robot is getting Near/Far to/from a wall, another robot, etc. If the sensor senses an object that is nearer than a certain distance, it will report a “Near” value. The robot can be programmed to do something when it gets near another robot, and do something else when it gets far from it.

After the students finish making the programming using CHERP, they simply connect the KIWI robot to the computer and transfer the program to the robot. The robot will remember the program by storing it on an electronic board. The robot can get disconnected from the computer but will be able to run the program as many times as the person wants.

The robot also includes a light output. The Light output can be programmed to turn on and off. Children can turn the color of the light output into different colors using transparent stickers or paper shades.

Construction with KIWI Parts

There are a total of four ports on the KIWI body as shown in FIG. 2.

Both the sensors and the light output can be attached to any of these ports. Therefore, the KIWI robot does not have different ports for inputs and outputs. The user can simply swap the sensors and the light output, and changing these places would not affect running the program that has been stored on the robot. Magnetic feature of the motor boxes and sensors makes attaching them to the main body and building the robot easy.

The power needed by the robot to function is provided by the 4 AAA batteries placed in the space on the back of the robot, or through its connection to the computer. Therefore, after the program transfers to the robot (the process is explained in the programming section), the robot can disconnect from the computer and function, only if all the 4 AAA batteries are in place. Otherwise, the robot needs to stay connected to the computer in order to function and run the program.

The only button existing on the robot is the start button. The robot starts running a program, only when the start button is pressed. This gives full control to the user to decide when to start functioning of the robot.

The distance sensor receives its input through a hole that is located on it. The hole needs to be aligned with the object/surface that is considered as the target that the object/surface is to get far from or close to.

The material that is used in the structure of the block (mostly wood), makes it possible for the young children to implement their artistic ideas, make the robots personal, and relate to them easier. While the magnetic aspect of the sensors and the motor boxes eliminates the challenge of placing these pieces on the robot, it resembles the process of making a puzzle that children are familiar with. Children can also attach string to the robot and use it as a car or animal robot. KIWI provides the opportunity of making arts and crafts as children can easily use recycling materials and stickers to decorate, and extend the wooden body of the robot.

Programming the KIWI Robot with CHERP

CHERP (Creative Hybrid Environment for Robotic Programming) is a hybrid tangible/graphical computer language designed to provide an engaging introduction to computer programming and robotics for children in both formal and informal educational settings.

### Tangible/Graphical Programming

CHERP enables one to create both physical and graphical computer programs to control the robot with icons that represent actions for the robot to perform. Physical programs are created using labeled interlocking blocks or onscreen programs using graphical versions of the icons. The shape of the interlocking blocks and icons creates a physical syntax that prevents the creation of invalid programs. CHERP programs can be downloaded to the robots in a matter of seconds.

### How It Works

CHERP's physical blocks contain no embedded electronics or power supplies. Instead CHERP uses a standard webcam connected to a desktop or laptop computer to take a picture of the program, which it then converts into digital code using the circular bar-code-like TopCodes on each block.

In the lab, interlocking wooden cubes are used as physical blocks. However, the use of blocks is not required. The graphical interface can be used as a stand-alone, or the icons can be printed and used them for tangible interaction.

Installation of CHERPK (the software that works with the KIWI robot)
Supported Platforms: Windows XP or better
System Requirements One USB 2.0 port

### Required Equipment:

The newest version of CHERP, called CherpK, works with both the embedded and external cameras. That means that it automatically detects any type of camera on a computer. Computers without an embedded camera can utilize an external camera. If a computer has both an embedded and an external camera, the external camera is the first choice to be used by the software. Therefore, the required equipment is:

Any type of webcam, embedded or external.

KIWI Construction Kit

Required Software (included with CherpK installer):

Java 7 Development Kit

### Testing the CHERP Interface

1. Make sure that the webcam (or external camera) is plugged in before starting CherpK. *If the camera is plugged into different USB port than when the driver was installed, the port is switched, so the software recognizes the external camera.* If an internal (embedded) camera is used, no further action is required.
2. Place the external webcam on a table aimed along the tabletop or on the table's edge looking down at the floor. If using an internal camera, make sure that it is aligned in the way that can capture a clear picture of the tangible icons/blocks. Leave at least 18 inches to two feet between the tangible icons/blocks and the webcam.
3. Double-click the CherpK desktop icon to open it. Click the icon showing three colored blocks (the Tangible Download button). This should capture an image from the webcam and display it on the right hand side of the screen.
a. If an error message indicating that the webcam is not plugged in is received, it means that no internal or external webcam was detected on the computer. Please double-check the connection and the webcam driver installation, unplug and re-plug the webcam (perhaps to a different port) and/or restart CherpK.
b. If an error message indicating that a Begin block is needed is received, the webcam is working.
4. Create a short Graphical program (e.g. Begin-End) and click the Graphical or Tangible Download button (FIG. 3). If everything is set up right, the robot will receive the program from the computer and start running the program when the start button located on its body is pressed.

### Interface Control

To enter and exit full-screen mode, hit Enter and Esc, on the keyboard. The system begins with only the first row of blocks (actions) showing. The second row contains REPEATS and their parameters and the third row contains IFS and their parameters.
Typing Ctrl+(1 or 2 or 3) when out of full-screen mode shows that number of rows.
   Programming with CHERP: Syntax

Either the Graphical Interface with the mouse or the Tangible Interface and printed icons can be used to create a program. FIG. 3 shows exemplary icons. The standard CHERP syntax is as follows:

Every program should start with a BEGIN block and end with and END block:

Control flow blocks such as IF, IF NOT, and REPEAT should be paired with their associated END block, with the action(s) to be controlled in between. IF NOT blocks can only be used after IF blocks.

REPEAT and IF blocks have a space for parameters. The coloring of the parameter icons matches that of their control flow block. For REPEAT blocks, adding a parameter is optional since the default is to REPEAT FOREVER. For IF blocks, the user should add a parameter.

In the Tangible Interface, the parameters' TopCodes should align with those of the other blocks and be visible to the camera to download the program to a robot (FIG. 4).

Programming with CHERP: Build and run a program by a Robot

1. Plug in the webcam (if an external webcam is used), before starting CherpK. Make sure CherpK is installed on the PC.
2. Open CherpK and build a program (see syntax guidelines above).
a. Graphical icons will only connect to a BEGIN block or to an already connected sequence of blocks. Unconnected graphical blocks will appear pale. Attach new blocks to the end or middle of a program by dragging and dropping the new block where you want to place it.
b. Icons are read by the computer and the robot in sequential order starting with the BEGIN block. Any icons not attached to a program chain starting with a BEGIN block will not be read.
c. To get rid of a Graphical icon or whole series of connected icons, drag them into the rows of available icons at the bottom of the screen.
3. For the Tangible Interface, place the Tangible blocks at least 18 inches to two feet away from the webcam.
a. If the icons are too close to the webcam, the computer vision will not see the program properly.
b. If an error that no BEGIN block is received, change the distance between the webcam and the program and re-download the program.
4. Connect the KIWI robot to the computer and press the appropriate download button (mouse for Graphical; blocks for Tangible; see below). After downloading the program, disconnect the robot from the computer and place it on a stable surface. Press the start button on the robot. The robot should start running the program immediately. *If all the required 4 AAA batteries are placed in the special place designed on the back of the robot, the robot can be disconnected from the computer and the USB cable after the program is uploaded to the robot, and start running the program by pressing the start button. In case all the batteries are not provided, the robot needs to be connected to the computer using the USB cable, at all times.
Using CHERP with KIWI Robot:

In some embodiments, the robot is built using a combination of KIWI parts, and recycled materials. To work with CherpK, the robot should conform to the following:

The process of programming the KIWI robot is relatively simple. The first and main step in programming the robot is to connect it to a USB port using a proper USB cable, and have it turned on.

On the back of the robot, there is a place designated to place 4 AAA batteries. It is important to note that the robot does not necessarily need the batteries to perform. If the batteries are placed in their special location, the robot can disconnect from the computer and run the program that has been updated on it. However, if any of the batteries is missing, the robot can still run the program that is uploaded on it but needs to stay connected to the computer to get the necessary power from the computer.

In order for any of the three sensors to function, they should attach to one of the four ports located on the robot. Since there are magnets designated in the body of the sensors and the light output, they can easily attach to the slots by being placed in the ports.

There are two motors, one light sensor, one distance sensor, one sound sensor, and one light output included in every kit. One, a few, or all the elements can be connected to the robot at the same time.

One program at the time is run using CHERP and the KIWI robot. Every time a program is built, the robot is reconnected to the computer (if it has been disconnected from the computer), and the new program is downloaded.

### How to Build the CHERP Blocks

One full set includes:

2 Begin Blocks (with peg, no hole)

2 End Blocks (no peg, with hole)

24 Regular Blocks, 2 each of:
o Forward
o Backward
Turn Left
Turn Right
Spin
Shake
Sing
Beep
Light On
Light Off
End-Repeat
End-If
If-Not
End-If-Not

4 Double Blocks:
2 Repeat
2 If

8 Parameter labels (not affixed to blocks):
Number labels 2-5 for use with REPEAT blocks
NEAR, FAR, LOUD, QUIET, LIGHT, DARK labels for use with IF blocks
UNTIL NEAR, UNTIL FAR, UNTIL LOUD, UNTIL QUIET, UNTIL LIGHT, UNTIL DARK labels for use with REPEAT blocks

### Materials:

36 1¾″ wooden craft cubes

40 ⅜″×1¼″ fluted pin dowels (or ⅜″ dowel, cut to size)

Yellow wood glue

Rubber cement or 3M spray adhesive

White card stock paper or printable sticker sheets for printing labels

Medium grade sandpaper

Optional:

Thick magnetic paper or Velcro coins for control flow blocks and parameters

### Tools:

10″ drill press

⅜″ drill bit

Drill press vice

Small hand saw (e.g. Tenon saw or Dovetail saw)

C-clamp or vice

Paper cutter (or access to a laser cutter!)

### Instructions for Building:

1. Current laboratory versions of CHERP are built out of 1¾″ wooden craft cubes. These cubes can be purchased from online vendors such as Barclaywoods.
2. Each block will have a ⅜″ hole drilled through the cube. This is best done with a 10″ drill press and a ⅜″ drill bit. Each cube should be clamped down with a vice and the hole should be drilled with the grain (drill into one of the end grain sides of the cube). It is important that the holes be drilled exactly into the center of the cubes so that the blocks line up straight when connected together in a program.
3. For the START and END blocks, holes should only be drilled half way through the cube. For the REPEAT and IF blocks, drill the holes only half-way through two cubes. Then use wood glue to glue the sides opposite the holes together to form double blocks.
4. Use wood glue to glue the pin dowels into the cubes. Spread glue on the bottom ½″ of the peg and twist it into the hole of the cube so as to distribute the glue evenly. The dowel should stick out ¾″ from the hole. You can use a penny (which has ¾″ diameter) to gauge the proper height.
5. After the glue has dried, sand the edges and corners of the blocks to make them smooth.
6. PDF files of the icons and parameters can be found on the CHERP website. Print out two copies of the icons and one copy of the parameters on printable sticker sheets or card stock using a color printer, and cut out each individual label with a paper cutter.

### Optional:

Print the labels for the parameters on magnetic paper so that the parameter icons can easily stick to the control flow blocks. This works best on a laser printer rather than an ink-jet printer.

7. If using magnetic parameters, glue 4 squares of magnet paper under the 4 parameter spaces on double-blocks.

If using card stock rather than sticker sheets, use rubber cement or 3M adhesive to glue the block labels onto the four outside faces of the cubes. It is important that the TopCode label be aligned as shown in the image above, with the dowel pointing to the right and/or the hole to the left. This ensures that the webcam is able to correctly identify the block.

If using Velcro coins to attach parameters, be sure to place the coins in the proper location to ensure that the parameters are in line with the other blocks. For instance, place Velcro coins on the bottom left corner of the REPEAT FOREVER spaces or in the center of the Ifs' empty parameter spaces, and place the other half of the coin in the corresponding spot on the parameters. Also be sure to place the correct half of the coin pairs (scratchy or fuzzy) on the block versus the parameter.

### Example 2

### Application of KWI to Early Childhood Education

### Study Design

The study used a combination of qualitative and quantitative data collection measures. Participating teachers completed a series of pre and post questionnaires in order to measure changes in their knowledge, attitudes, and sense of self-efficacy after participating in the three-day professional development institute. Additionally, teachers' interviews were used to collect qualitative data during and after the institute.

All surveys were conducted online and implemented before and after the workshop. Those who had not completed all pre-surveys prior to attending the institute were asked to fill them out on the first day of the institute (before any activities had started) using computers provided on site. At the end of the third and final day of the institute, all the teachers were also asked to complete and submit post-surveys on site. A 5-point Likert scale was used for answering the questions in all three surveys (pre and post). For all questions, teachers could choose to: Strongly Disagree, Disagree, Neither Agree/Nor Disagree, Agree, or Strongly Agree with the statements in all of the surveys.

A self-selected sample of early childhood educators (N=32) from across the United States participated in this study. Participants were actively teaching in a Pre-K-2nd grade classroom and could be present for the full duration of the institute. No previous technology expertise was required. Participants varied widely in their experience teaching ranging from 4 to 38 years of experience (mean=15.12, SD=8.2). The majority of teachers (73%) were attending with a colleague from their school or district and all teachers (100%) said that were planning to collaborate with a colleague on implementing their robotics curriculum upon returning to their school. Prior to the institute, the majority of teachers (58%) considered themselves average users of technology, while 39% considered themselves expert users and only 4% considered themselves novices. In terms of teaching with technology, only 39% of teachers considered themselves experts, while 30% considered themselves average and another 31% considered themselves novices.

The institute described here consisted of three days of robotics and programming (a total of 18 hours) focused professional development activities for 32 early childhood educators, for which these teachers had the opportunity to earn professional development points. A combination of lecture, large and small group discussions, and hands-on work with the KIWI robotics construction sets and CHERP programming software were used (See Example 1).

### RESULTS

Of the 32 teachers participating in the summer professional development institute, data was included in analysis for a final sample of N=25 teachers who completed and submitted all pre and post survey responses. In order to determine changes in teachers' knowledge and attitudes as a result of participation in the institute, pre and post comparisons using two-tailed T-tests were used. Prior to this, preliminary analyses were performed to ensure no violation of the assumptions of normality and linearity of all data sets. Results show statistically significant increases in the level of knowledge in all the three areas of technology, pedagogy, and content knowledge after participation in the institute. Additionally, results show significant increases in several aspects of technology self-efficacy and attitudes toward technology (Table 1).

TABLE 1
Significant Increases in Knowledge after Participation in the Institute

| | Mean | Mean | Mean | |
|---|---|---|---|---|
| Knowledge Survey Items | Pre | Post | Difference | t |
| Knowledge of what | 3.0 | 4.6 | 1.6*** | −7.9 |
| makes a device a robot. | (1.0) | (1.0) | | |
| Knowledge of the main | 2.6 | 4.5 | 1.9*** | −9.3 |
| components of a robot. | (1.0) | (1.0) | | |
| How a robot is given | 2.8 | 4.6 | 1.8*** | −10.7 |
| instructions. | (0.9) | (0.9) | | |
| Stages of the Engineering | 2.4 | 4.4 | 2.0*** | −7.8 |
| Design Process. | (1.4) | (1.4) | | |
| How to apply the Engineering | 2.2 | 4.2 | 2.0*** | −9.8 |
| Design Process in activities. | (1.2) | (1.2) | | |
| Knowledge of effective teaching | 2.6 | 4.2 | 1.6*** | −6.4 |
| approaches to guide students' | (1.3) | (1.3) | | |
| thinking and learning in robotics. | | | | |
| How to teach the construction | 2.2 | 4.2 | 2.0*** | −9.6 |
| aspects of robotics. | (1.0) | (1.0) | | |
| How to teach the programming | 2.4 | 4.3 | 1.9*** | −9.6 |
| aspects of robotics. | (1.2) | (1.2) | | |
| How to teach robotics in a | 2.4 | 4.3 | 1.9*** | −9.8 |
| developmentally appropriate way | (0.9) | (0.9) | | |
| How to integrate robotics into | 2.5 | 4.5 | 2.0*** | −8.2 |
| other traditional content areas | (1.0) | (1.0) | | |
| How to use robotics to enhance | 3.5 | 4.5 | 1.0*** | −4.3 |
| students' problem solving skills. | (1.4) | (1.4) | | |
| How to use Engineering Design | 2.3 | 4.3 | 2.0*** | −7.5 |
| Process to teach robotics. | (1.2) | (1.2) | | |
| How to use robotics to enhance | 3.4 | 4.6 | 1.2*** | −4.2 |
| students' collaboration skills. | (1.4) | (1.4) | | |
| How to plan student-centered | 2.9 | 4.5 | 1.6*** | −7.7 |
| robotics projects | (1.2) | (1.2) | | |
| How to implement student- | 2.9 | 4.2 | 1.3*** | −5.4 |
| centered robotics projects in the | (1.2) | (1.2) | | |
| How to assess students' learning | 2.6 | 4.0 | 1.4*** | −6.3 |
| in robotics. | (1.2) | (1.2) | | |
| How to assess students' learning | 2.7 | 4.0 | 1.3*** | −5.3 |
| when integrating robotics with | (1.2) | (1.2) | | |
| other traditional content areas | | | | |
| Have used CHERP in | 1.4 | 1.6 | 0.2 | −0.74 |
| the past | (0.8) | (0.8) | | |
| How to program a robot | 1.4 | 4.2 | 2.8*** | −12.3 |
| using CHERP | (1.0) | (1.0) | | |
| How to program with CHERP, using | 1.3 | 4.4 | 3.1*** | −17.9 |
| both the tangible and graphical versions. | (0.6) | (0.6) | | |
| Understanding of the different | 1.2 | 4.1 | 2.9*** | −13.8 |
| messages (including the error | (0.5) | (0.5) | | |
| messages) given by CHERP. | | | | |
| How to access all rows of programming | 1.2 | 4.2 | 3.0*** | −14.6 |
| blocks (to use Repeats, Sensors, etc.) | (0.5) | (0.5) | | |
| in the graphical version of CHERP. | | | | |
| Able to construct a sturdy | 1.2 | 4.3 | 3.1*** | −12.6 |
| KIWI robot. | (0.6) | (0.6) | | |
| Knowledge of the power source | 1.2 | 4.5 | 3.3*** | −17.6 |
| of KIWI is. | (0.5) | (0.5) | | |
| How to program KIWI | 1.2 | 4.5 | 3.3*** | −20.7 |
| using CHERP. | (0.5) | (0.5) | | |
| How the CHERP program gets | 1.1 | 4.4 | 3.3*** | −18.4 |
| transferred to the KIWI robot | (0.4) | (0.4) | | |
| How to build a moving robot | 1.2 | 4.5 | 3.3*** | −16.8 |
| using KIWI and CHERP. | (0.6) | (0.6) | | |
| How to build a sensing robot | 1.0 | 3.9 | 2.9*** | −13.8 |
| using KIWI and CHERP. | (0.2) | (0.2) | | |

Note
*** = p < .001.
N = 25 and df = 24 for all analyses.
Standard Deviations appear in parentheses below means

Despite the growing interest in the field of robotics as an educational tool, little effort is focused on the foundational schooling years. For decades, early childhood curricula have focused primarily on literacy and math, especially with the educational reforms of No Child Left Behind (Zigler & Bishop-Josef, 2006). Only recently has educational reform across organizations begun to address technology learning standards and best practices for integrating technology into early childhood education (International Society for Technology in Education (ISTE), 2007; National Association for the Education of Young Children (NAEYC) & Fred Rogers Center, 2012; United States Department of Education (U.S. DOE), 2010). Considering this, it is not surprising that early childhood educators generally demonstrate a lack of knowledge and understanding about technology and engineering, and about developmentally appropriate pedagogical approaches to bring those disciplines into the classrooms (Bers, 2008). New professional development models and strategies, such as the institute described herein, prepare early childhood teachers for the task of implementing best practices for integrating technology into their classrooms.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A system for use by a child aged 7 or younger, comprising:
a) a robot comprising i) a robot body; ii) at least one sensor port configured to receive at least one sensor; and iii) at least one motor port configured to receive at least one motor; and
b) a programming interface configured to receive graphical and/or tangible programming instructions and transmit said instructions to said robot body, wherein said programming interface and said robot are configured for use by a child aged 7 or younger.

2. The system of claim 1, wherein said sensors are selected from the group consisting of sound sensors, light sensors, and distance sensors.

3. The system of claim 1, wherein said robot further comprises a light output.

4. The system of claim 1, wherein said tangible programming instructions comprise physical objects comprising printed programming instructions.

5. The system of claim 1, wherein said system further comprises a camera.

6. The system of claim 1, wherein said programming interface comprises a computer processor and computer software.

7. The system of claim 1, wherein said programming instructions comprise one or more instructions are selected from the group consisting of BEGIN, END, FORWARD, BACKWARD, TURN LEFT, TURN RIGHT, SPIN, SHAKE, SING, BEEP, LIGHT ON, LIGHT OFF, END-REPEAT, END-IF, IF-NOT, END-IF-NOT, REPEAT, IF, NEAR, FAR, LOUD, QUIET, LIGHT, DARK, UNTIL NEAR, UNTIL FAR, UNTIL LOUD, UNTIL QUIET, UNTL LIGHT, and UNTIL DARK.

8. The system of claim 1, wherein said robot body further comprises a communications component for communicating with said programming interface.

9. The system of claim 1, wherein system is configured for use by a child ages 4-7.

10. The system of claim 1, wherein said sensors, motors, sensor ports, and motor ports comprise magnets configured to attach said sensors to said sensor ports and said motors to said motor ports.

11. The system of claim 1, wherein said sensors and said sensor ports are modular.

12. The system of claim 1, wherein said system comprises 3 or fewer motors and motor ports; 4 or fewer sensors and sensor ports; and one light output.

13. The system of claim 1, wherein each of said programming instructions corresponds to a single robot action.

14. The system of claim 1, wherein said robot remains intact if the robot contacts a solid surface.

15. The system of claim 1, wherein said system is configured to teach literacy and math.

16. A method, comprising:
a) programming a sequence of commands using a programming interface configured to receive graphical and/or tangible programming instructions, wherein said programming is configured to be performed by a child aged 7 or younger; and
b) transmitting said instructions to a robot comprising i) a robot body; ii) at least one sensor port configured to receive at least one sensor; and iii) at least one motor port configured to receive a motor.

17. The method of claim 16, wherein said method is performed by a child ages 4-7.

18. The method of claim 16, wherein performing said method teaches literacy and math and a child under the age of 7.

19. A kit, comprising:
a) the system of claim 1; and
b) one or more instructional components selected from the group consisting of printed curriculum instructions, an instructional video, and teaching aids.

20. The kit of claim 19, wherein said kit is configured for use by a child ages 4-7.
